(19) United States
(12) Patent Application Publication
(10) Pub. No.: US 2016/0018512 A1
(43) Pub. Date: Jan. 21, 2016

(54) Method for Generating and Compressing Multi-Sweep-Frequency Radar Signals

(71) Applicant: WUHAN UNIVERSITY, Wuhan, Hubei (CN)

(72) Inventors: Biyang WEN, Wuhan, Hubei (CN); Jian TAN, Wuhan, Hubei (CN); Ke LI, Wuhan, Hubei (CN); Yingwei TIAN, Wuhan, Hubei (CN); Caijun WANG, Wuhan, Hubei (CN)

(73) Assignee: WUHAN UNIVERSITY, Wuhan, Hubei (CN)

(21) Appl. No.: 14/773,255

(22) PCT Filed: Nov. 5, 2013
(86) PCT No.: PCT/CN2013/086521

§ 371 Date: Sep. 4, 2015

(30) Foreign Application Priority Data
Jun. 21, 2013 (CN) 201310251370.8

(51) Int. Cl. G01S 7/282; G01S 7/288

(52) U.S. Cl. CPC G01S 7/282; G01S 7/288; G01S 2007/2883

(57) ABSTRACT

A method for generating and compressing multi-sweep-frequency radar signals is provided, based on the idea of reducing the power density of signals on a time-frequency domain. By using a method of circumferentially shifting and superposing a single sweep-frequency signal, sweep-frequency signals multiplexed simultaneously at time and frequency are generated, and for the generated multi-sweep-frequency signals, the sweep-frequency signals are multiplexed simultaneously at time and frequency in a single pulse time period. The multi-sweep-frequency signals multiplexed at frequency are used to perform matched filtering, and then perform segmented accumulation to obtain distance resolution which is inversely proportional to the bandwidth and the signal-to-noise ratio after the single sweep-frequency signal is compressed under the same energy condition, thereby realizing secondary compression on the multi-sweep-frequency signals. The signals generated by the method have higher spectrum utilization rate and lower interception probability, and guarantee the distance resolution and detection distance of a radar.

### BACKGROUND OF THE INVENTION

1. Field of the Invention

The present invention belongs to the field of radar technology, and more particularly to a time and frequency division multiplexed multi-sweep-frequency radar signals and the corresponding generating/compressing method.

2. Description of Related Art

In radar system the target range and velocity information is obtained by transmitting the electromagnetic wave and measuring the echo delay and Doppler shift from the target. A good isolation between the transmitting and receiving can be achieved in simple poise radar transceiver, but the conflicts between high range resolution and long detection distance can't be solved. It is known that the narrow pulse results in high range resolution and the long detection distance needs more energy. As a result, the high power density makes the transmitter hard to implement and has serious impact on the surrounding electromagnetic environment. Pulse compression is a technology using phase compensation to compress all frequency signals energy into a time point. The resolution of the radar signal is only related to bandwidth, not the pulse width. The radar transmitted power can be reduced greatly and the spectrum resources are utilized adequately due to the pulse compression technology.

FIG. 1 exhibits different radar signals and their corresponding time-frequency power density diagram. In order to obtain the high range resolution and long detection distance, the power density of simple pulse signal shows a high column in the time frequency plane. For single-carrier phase-coded signal and chirp signal, their power densities arc a cross strip along the time axis and oblique strip along the tune-frequency axis, respectively. The energy distributed in the time frequency plane can be collected into a time point to meet the range and resolution requirement, so that the power density of transmitted signal can be reduced enormously. Similarly, Jankirman. M has studied and applied the multi-carrier frequency chirp technology. Levanon has designed Multi-carrier frequency complementary phase (MCPC) signals applied to radar system based on OFDM signal applications in communication. Both of them are successful in ensuring the large time-bandwidth product and reducing the power density of the time-frequency domain.

With the radio applications of electronic devices further promoting, the lower power density requirements have been put forward. A lower power density and more optimal radar signal generating method is the inevitable trend of development. Compared with the traditional radar signals, the MCPC radar signal has high spectrum efficiency, but is more sensitive to Doppler shift and more sophisticated to be generated and compressed.

### SUMMARY OF THE INVENTION

Aiming at the technical problems in the background, the present invention provides a multi-sweep-frequency radar signal and its generating/compressing method. It is mainly to solve the problem of large power density in time frequency plane and low spectrum utilization. The energy of the proposed signals is distributed on the multiplexed sweep signals which achieve the same high range resolution and long detection distance as a single sweep signal; unlike multi-carrier frequency chirp technology, the sweep bandwidth in our signals may be ignored relative to the carrier frequency. Also it's easy to implement on hardware system as the sweep signals.

In order to solve the above technical problems, the present invention adopts the following technical scheme:

A method of generating multiple sweep radar signals, comprises the steps of:

Step 1, utilizing the CORDIC algorithm to generate constant amplitude sweep digital signal g₀(n);

Step 2, determining the sweep signal interval t_{b}, and cyclic shift g₀(n) by (m=1)t_{b} (1≦m≦M), obtain M Sweep digital signal gₘ(n);

Step 3, accumulating die digital domain multiple sweep signal, obtained as follow;

$$g ( n ) = {\sum }_{m = 1}^{M} {g}_{m} ( n ) .$$

Step 4, converting the digital signal g(n) to analog domain g(t), then transmit it to an antenna after being magnified and filtered.

A method of compressing the above-mentioned sweep radar signals, contains the following steps:

Step 1, using frequency division multiplexed multi-sweep-frequency signal as a conjugate transpose of impulse response;

Step 2, frequency weighting for the impulse response;

Step 3, matching filter by using the impulse response of the weighted multi-sweep-frequency echo signals;

Step 4, dividing the results of matched filter into M+1 segments with equal length t_{b} and accumulate them respectively, to achieve the multi-sweep-frequency pulse compression.

As mentioned above, the multi-sweep-frequency radar signal is time and frequency division multiplexed simultaneously. The frequency interval of arbitrary time is bigger than the expected maximum Doppler shift, the corresponding time interval for arbitrary frequency should be longer than the-echo's delay.

In the above multi-sweep-frequency radar signal compression method, a matched filter in the frequency domain is used to achieve pulse compression, the resolution is inversely proportional to signal bandwidth. Frequency weighting can effectively reduce the pulse compression side lobes with main lobe broadening.

Compared with the traditional signal, the present invention has the following advantages and positive effects:

1. The multi-sweep-frequency signals generated by the present invention are in time and frequency division multiplexed which achieves the time and frequency diversity. The power density in the time-frequency domain is decreased as possible; compared with a single sweep signal, the same distance resolution and compression SNR can be achieved in case of the same energy and bandwidth; a low probability of intercept and good anti-jamming features can also be obtained because of the multi-frequency transmitted simultaneously.

2. The energy of proposed multi-sweep-frequency signals are uniformly distributed in the time-frequency domain, with efficient spectrum utilization; a precise measurement of the target speed and distance can be implemented due to the ambiguity function of the nail plate.

### BRIEF DESCRIPTION OF THE DRAWINGS

FIG. 1 shows the power density of different radar signals, including the multi-sweep-frequency radar signal generated by the present invention.

FIG. 2 is the time-frequency distribution of eight sweeps time and frequency division multiplexed radar signal.

FIG. 3 is a block diagram of multi-sweep-frequency radar signal generating method.

FIG. 4 shows the pulse compression component of multi-sweep-frequency radar signal.

FIG. 5 is a schematic diagram of the radar signal pulse compression method.

FIG. 6 is the first compression results for time and frequency multiplexed eight-sweep signal.

FIG. 7 is a schematic diagram of weighting a single sweep signal.

FIG. 8 is a schematic diagram of weighting time and frequency multiplexed multi-sweep-frequency signal.

FIG. 9 is the first compression results of multi-sweep-frequency signals (windowing).

FIG. 10 is the first compression results of multi-sweep-frequency signal.

FIG 11 is the second compression results of multi-sweep-frequency signal.

FIG. 12 illustrates the pulse compression results for a single sweep signal in an overall view.

FIG. 13 illustrates the pulse compression results for a single sweep signal in a partial view.

### DETAILED DESCRIPTION OF THE PREFERRED EMBODIMENTS

One or more implementations of the present invention will now be described with reference to the attached drawings.

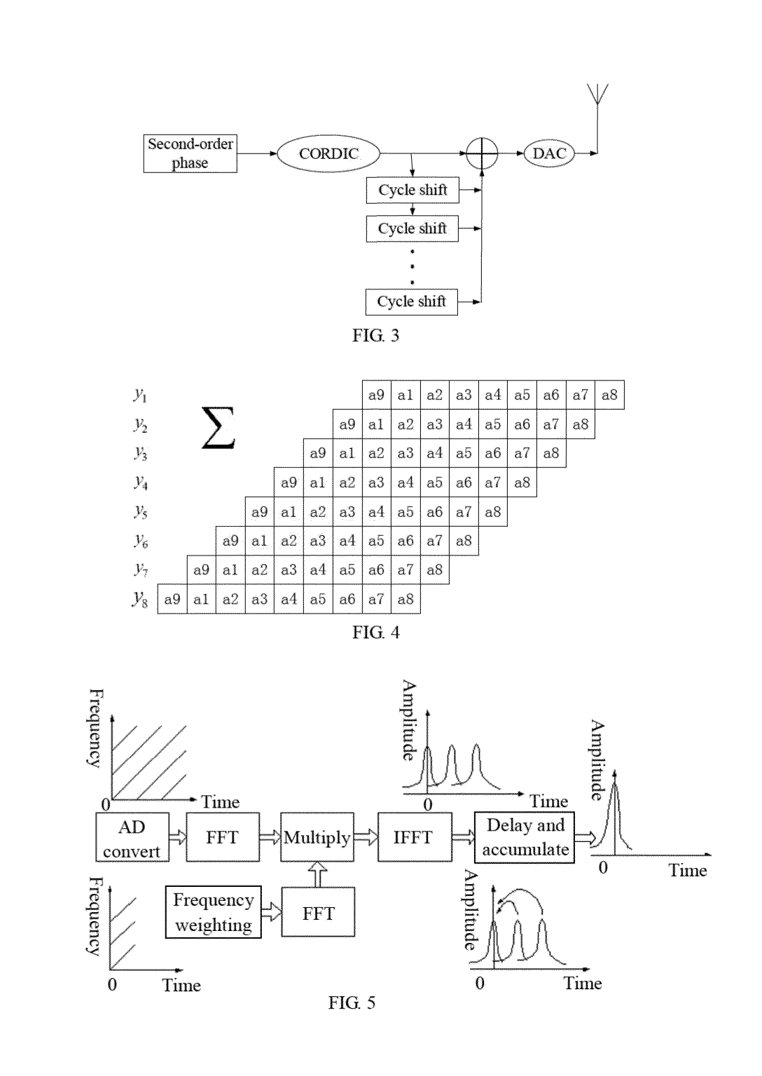

FIG. 3 shows the block diagram of the multi-sweep-frequency signal generation method, as the following steps:

Step 1, utilizing the CORDIC algorithm to generate constant amplitude sweep digital signal g₀(n);

Step 2, determining the sweep signal interval t_{b}, and cyclic shift g₀(n) by (m−1)t_{b} (1≦m≦M), obtain M Sweep digital signal gₘ(n);

Step 3, accumulating the digital domain multiple sweep signal, obtained as follow;

$$g ( n ) = {\sum }_{m = 1}^{M} {g}_{m} ( n )$$

Step 4, converting the digital signal g(n) analog domain g(t), then transmit it to an antenna after being magnified and filtered.

The multi-sweep-frequency signals with M sweeps in time division multiplexed and N sweeps in frequency division multiplexed, is given by:

$$g ( t ) = {\sum }_{m = 1}^{M} {\sum }_{n = 1}^{N} {w}_{n} s [ t - ( m - 1 ) {t}_{b} ] \times exp [ 2 πj ( {f}_{0} + \frac{1}{2} k ( t + ( n - m ) {t}_{b} ) ) ( t + ( n - m ) {t}_{b} ) + j θ ( n , m ) ] \qquad ( 1 )$$

Where k denotes the sweep slope, f₀ is the carrier frequency, θ(n, m) represents the initial phase of n-th sweep signal during m-th period, wₙ denotes the weight for n-th sweep signal. Then s(t) is a rectangular window with time width t_{b} shown as:

$$\begin{matrix}s ( t ) = 1 , & 0 \leq t < {t}_{b} \\ = 0 , & else\end{matrix} \qquad ( 2 )$$

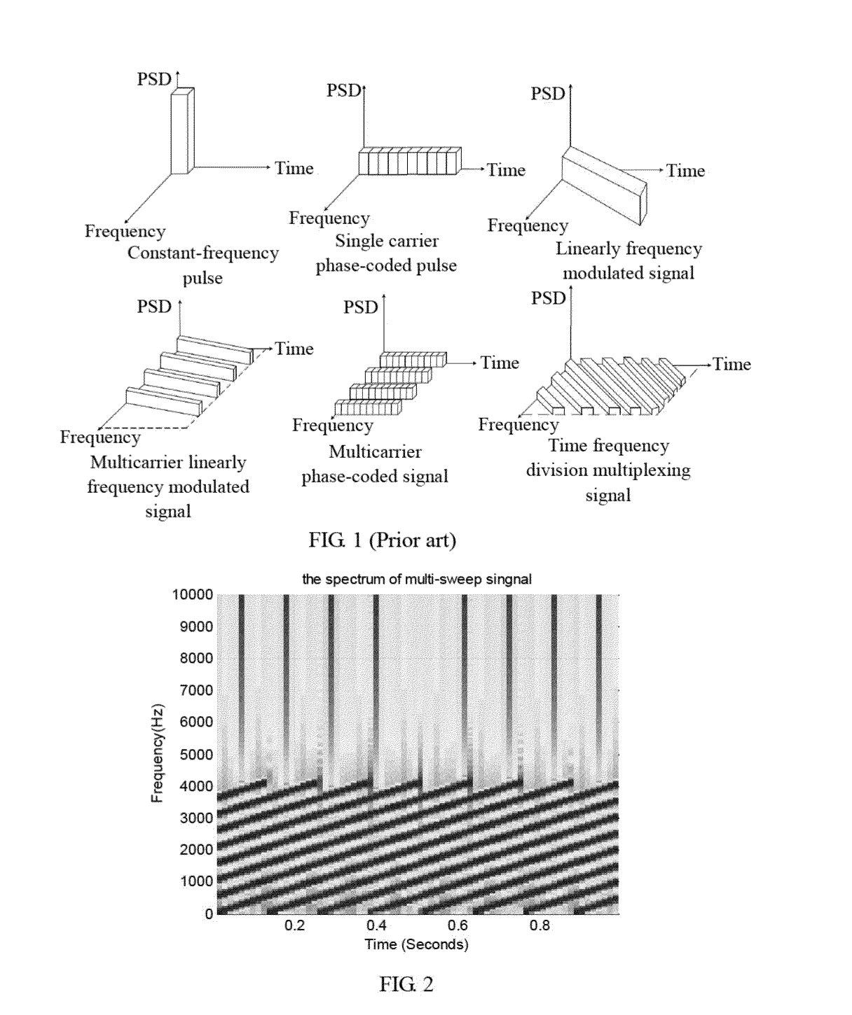

Specially, in the case of M=1 the signal becomes frequency division multiplexed sweep signal; when N=1, the signal evolves into a time division multiplexed multi-sweep-irequency signal; For the situation M=N, θ(n, m)=0, it can be seen as a summation of M sweeps which are formed by cyclic shifting a single sweep. Here the single sweep is with duration Mt_{b} and shifting length is t_{b}; for M=N=1, the multi-sweep-frequency signal turns into a single sweep. FIG 2 depicts the time-frequency distribution of the proposed multi-sweep-frequency signal. The following describes the special case of M=N and θ(n, m)=0, and proposes the generating/compressing method.

The principle of pulse compression is using the signal phase compensation to map different frequency components uniformly to a narrow pulse, so as to solve the conflict of high resolution and long detection distance. As a way to achieve pulse compression, match filter equals to the auto-correlation function of the signal. Consequently the auto-correlation has been discussed to analyze the signal's character instead of pulse compression.

From another perspective the proposed signal comprises M frequency division multiplexed multi-sweep-frequency signals with a duration t_{b}. Suppose that the frequency division multiplexed multi-sweep-frequency signal g_{1N}(t) is expressed as:

$${g}_{1 N} ( t ) = {\sum }_{n = 1}^{N} s [ t ] \times exp [ 2 π j ( {f}_{0} + \frac{1}{2} k ( t + ( n - 1 ) {t}_{b} ) ) ( t + ( n - 1 ) {t}_{b} ) + jθ ( 1 , n ) ] \qquad ( 3 )$$

Shift equation (3) by (m−1)t_{b}, m=1, . . . M in time domain, we can get g_{mN}(t)=g_{1N}(t−(m−1)t_{b}), frequency division multiplexed multi-sweep-frequency signal is:

$$g ( t ) = {\sum }_{m = 1}^{M} {g}_{mN} ( t ) \qquad ( 4 )$$

Compared with the transmitted signal, the echo signal has amplitude attenuation and contains noise. With a certain time delay and Doppler shift, it can be described as:

$${g}^{′} ( t ) = {\sum }_{m = 1}^{M} {g}_{mN}^{′} ( t ) \qquad ( 5 )$$

According to the theory of matched filtering, pulse compression obtained results:

$$\begin{matrix}y = {g}^{*} ( - t ) * {g}_{M}^{′} ( t ) \\ = {\sum }_{n = 1}^{M} {g}_{nN}^{*} ( - t ) * {\sum }_{m = 1}^{M} {g}_{mN}^{′} ( t ) \\ = {\sum }_{n = 1}^{M} {\sum }_{m = 1}^{M} {g}_{nN}^{*} ( - t ) * {g}_{mN}^{′} ( t ) \\ = {\sum }_{n = 1}^{M} {y}_{n}\end{matrix} \qquad ( 6 )$$

Wherein

$${y}_{n} = {\sum }_{m = 1}^{M} {g}_{nN}^{*} ( - t ) * {g}_{mN}^{′} ( t )$$

shows the compression result of echo signal. As the reference signal, the frequency division multiplexed signal g_{mN}(t) is shifted by t_{b} to get the sequence g*_{(n+1)N}(−t). According to the property of the linear convolution, we know that yₙ₊₁(τ)=yₙ(τ+t_{b}). Shown in FIG. 4, the result yₙ consists of M segments described by aᵢ, i=1,2 . . . M, M+1, which represents the convolution result of g*_{1N}(−t) and g*_{iN}(t) if the side lobes and noise are ignored. Note that aᵢ(i=1,2 . . . M) with the length t_{b} contain the echo delay information. Considering expression of the results y, the useful data which contains echo energy is

$${\sum }_{i = 1}^{M} {a}_{i} .$$

In order to simplify the calculation, just get the result y₁, and divide it into M+1 slices, then accumulate the segments to reflect pulse compression result which contains target delay information. FIG. 5 exhibits the pulse compression method of proposed multi-sweep-frequency signal by the following steps:

1) using h(n)=g*₁ₙ(−n) as the impulse response of matched filter;

2) shaping the impulse response with a weight window;

3) padding h(n) with zeros, then transform it into Fourier domain;

4) converting the echo signal into digital signal and compute its fast Fourier transform(FFT);

5) An inverse last Fourier transform(IFFT) is performed on multiplication of the above two FFT results, to obtain the first compression results of multi-sweep-frequency signal;

6) The results of the first compression are divided into M+1 segments with length t_{b}, then the multi-sweep-frequency secondary compression is achieved by accumulating the slices.

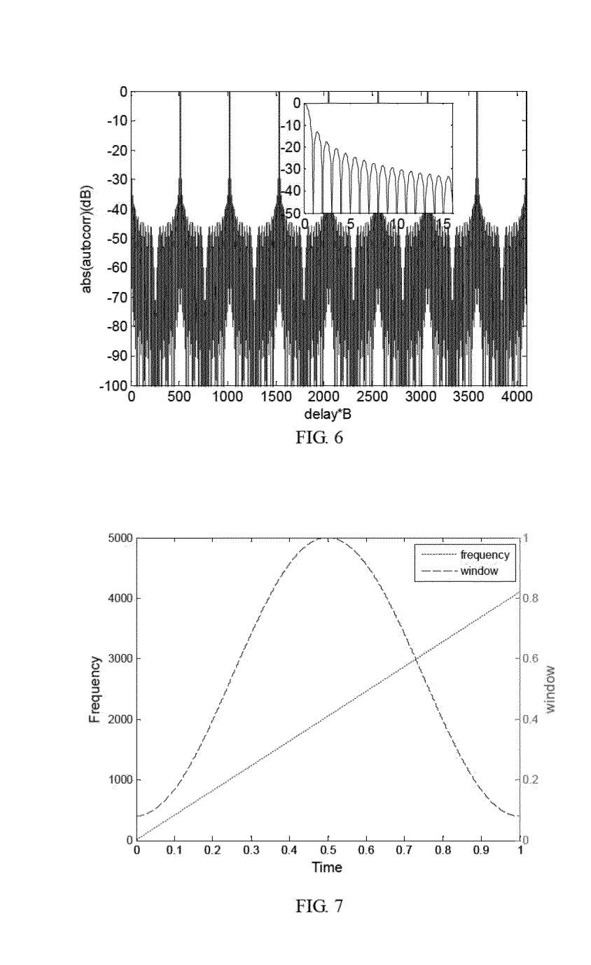

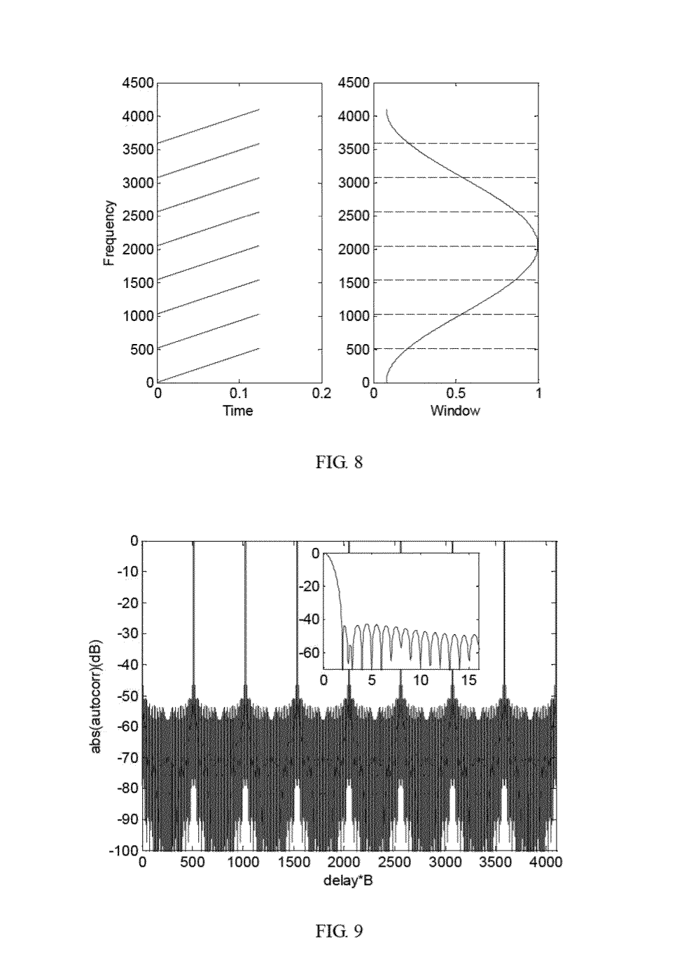

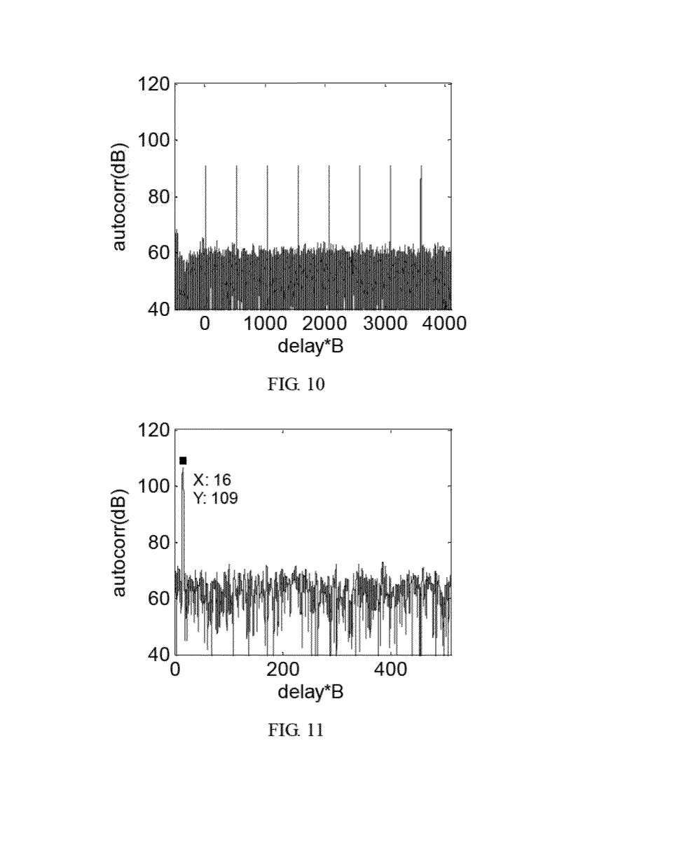

In the single sweep signal processing, the frequency weighting is usually used to reduce compression side lobes, so as to avoid the side lobe of strong signals overshadowing the main lobe of weak signals. Here the frequency weighting is also considered to suppress sidelobes for the multi-sweep-frequency signal. The common Cosine window used are as follows:

$${W}_{n} = {[ {a}_{0} + {a}_{1} cos \frac{2 π ( n - 1 / 2 )}{I} ]}^{n} , n = 1 , … , I \qquad ( 7 )$$

where I expresses the length of window. In the case of a₀=0.54, a₁=−0.46 and a=1, the above coefficient represents Hamming window. FIG 7 shows schematic diagram of weighting a single sweep signal, which presents an upside down “bell” shape with bigger weight in the middle and smaller weight at both ends. After all frequencies were compressed together, the side lobes can be reduced with the major lobe broadening. In the proposed invention the transmitted signals are time and frequency multiplexed multi-sweep-frequency signal, the reference signal for matched filter is frequency multiplexed multi-sweep-frequency signal at the receiving end with the frequency weighting. FIG. 8 shows frequency division multiplexed multi-sweep-frequency signal weighted schematic, which is an analogy to weighting pattern of single sweep signal. We can see that the entire window coefficient is divided into M segments of equal length, weighting the different segments, and ultimately the entire band width of the inner weighted. FIGS. 6 and 9 describes the first compression results map without and with frequency weighting, respectively. Note that the weight has a significant improvement for the side lobe level decreasing from −13 dB to −40 dB.

The time width after matched filtering is compressed into 1/B (B is the sweep bandwidth). That is to say, the multiplexed signal will achieve the same range resolution when they occupy the same frequency bandwidth as a single sweep. FIG. 10 displays the first compression results for multi-sweep-frequency signal, where the half-power width of main lobe is 1/B. So the range resolution equals c/(2B). It is obvious that the range resolution of multi-sweep-frequency signal is only to do with the bandwidth. Compared to a single sweep signal in the same bandwidth and the same energy conditions, the multi-sweep-frequency signal spreads energy over a plurality of time points and a plurality of frequency points. In other words, the power per time unit and frequency unit becomes smaller. Under the assumption that the signals contain the same noise, we compare the pulse compression of single sweep signal with multi-sweep-frequency signals. The single sweep signal amplitude is √M times bigger than each subsweep in multi-sweep-frequency signal. A pulse compression SNR formula is expressed as:

SNR=2E/N₀

Here E is the signal energy, N₀ represents the noise spectral density, the above SNR formula is satisfied only when all signal energy is compressed. In the compression method of the present invention, the first compression does not realize all the energy compaction, but the energy is concentrated in the M segments equal time intervals. So until now the SNR is M times less than that for single sweep signal. By the above analysis, the first compression results present M segments which have same amplitude. Regard to the impact of Doppler frequency shift, they are all in the same initial phase. In the process of the second compression of the multi-sweep-frequency signal, the matched filtering was divided into M+1 segments evenly, and each segment performs the accumulation successively. FIG. 11 shows the eventual outcome of this process, which is equivalent to finish the signal coherent integration, and improve signal to noise ratio M times, to achieve the same SNR as the single sweep pulse compression.

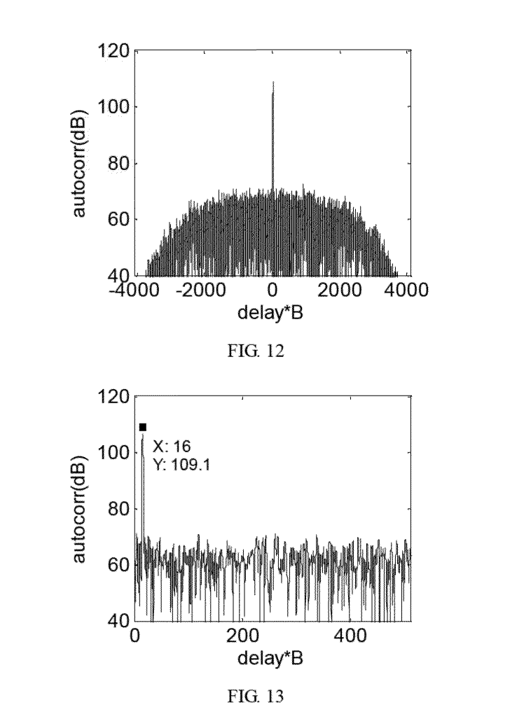

In order to further illustrate the above theory of the same SNR, now the simulation results have been shown. FIGS. 12 and 11 shows the compressed results of single sweep signal and multi-sweep-frequency signal with noise and time delay, respectively. The echo signals carry the same energy and contain the same noise. In the compressed results of single sweep signal, the noise level is 70 dB (herein relative value is applied), the target peak reaches 109 dB. As for multi-sweep-frequency signal compression, the energy distributes in the M slices with time lengthy, and after the second compression, coherent accumulation obtains the results shown in FIG. 11. Note that, echo energy all be focused into a pulse with time width 1/B after secondary compression. Then the noise level and target peak level is consistent with FIG. 13. It's known from the perspective of the simulation, the compression for multi-sweep-frequency signals can be completed in the same compression process as a single sweep signal, and achieve the same SNR.

What is claimed is:

1. A method for generating a multi-sweep-frequency of a radar signal, wherein comprises following steps:
Step 1, utilizing the CORDIC algorithm to generate constant amplitude sweep digital signal g₀(n);
Step 2, determining the sweep signal interval t_{b}, and cyclic shift g₀(n) by (m−1)t_{b} (1≦m≦M), obtain M Sweep digital signal gₘ(n);
Step 3, accumulating the digital domain multiple sweep signal, obtained as follow; and
$$g ( n ) = {\sum }_{m = 1}^{M} {g}_{m} ( n )$$
Step 4, converting the digital signal g(n) to analog domain g(t), then transmit it to an antenna after magnified and filtered.

2. A method for compressing the multi-sweep-frequency of the radar signal according to claim 1, further comprising following steps:
Step 1, using a transmission signal of more than a period of the frequency sweep signals multiplexed conjugate transpose as the impulse response;
Step 2, weighting the frequency of the impulse response;
Step 3, using the impulse response of weighted multi sweep echo signals matched filtering; and
Step 4, dividing the matched filtering result into M+1 segments with equal time length t_{b} and sub-accumulate, to achieve the secondary compression.
